(19) United States
(12) Patent Application Publication
(10) Pub. No.: US 2015/0379921 A1
(43) Pub. Date: Dec. 31, 2015

(54) Organic Light-Emitting Diode Display With Supplemental Power Supply Distribution Paths

(71) Applicant: Apple Inc., Cupertino, CA (US)

(72) Inventors: Jungmin Lee, Cupertino, CA (US); Donghee Nam, Incheon (KR); John Z. Zhong, Saratoga, CA (US); Jueng-Gil J. Lee, Cupertino, CA (US)

(21) Appl. No.: 14/318,348

(22) Filed: Jun. 27, 2014

(51) Int. Cl. G09G 3/32

(52) U.S. Cl. CPC G09G 3/3208; G09G 2300/0408

(57) ABSTRACT

An organic light-emitting diode display may have thin-film transistor circuitry formed on a substrate. A pixel definition layer may be formed on the thin-film transistor circuitry. Openings in the pixel definition layer may be provided with emissive material overlapping respective anodes for organic light-emitting diodes. A cathode layer covers the array of pixels. Patterned metal on the pixel definition layer may assist the cathode layer in distributing a power supply voltage to the organic light-emitting diodes. The patterned metal may be overlapped by patterned black masking material on an encapsulation layer such as a color filter layer. The pixel definition layer may also be formed from metal that is coated with inorganic dielectric. The cathode may be shorted to a metal pixel definition layer through openings in the inorganic coating.

### BACKGROUND

This relates generally to electronic devices and, more particularly, to electronic devices with organic light-emitting diode displays.

Electronic devices often include displays. For example, an electronic device may have an organic light-emitting diode display based on organic-light-emitting diode display pixels. Each pixel may have a pixel circuit that includes a respective light-emitting diode. Thin-film transistor circuitry in the pixel circuit may be used to control the application of current to the light-emitting diode in that pixel. The thin-film transistor circuitry may include a drive transistor. The drive transistor and the light-emitting diode in a pixel circuit may be coupled in series between a positive power supply and a ground power supply.

Signals in organic-light-emitting diode displays such as power supply signals may be subject to undesired voltage drops due to resistive losses in the conductive paths that are used to distribute these signals. If care is not taken, these voltage drops can interfere with satisfactory operation of an organic light-emitting diode display.

Organic light-emitting diode displays have cathodes formed from blanket layers of conductive material. Power supply uniformity can be enhanced by reducing cathode resistance. Cathode resistance can be reduced by increasing cathode thickness or by providing a secondary cathode layer on the underside of an encapsulation layer that is shorted to a primary cathode layer on a thin-film transistor substrate. However, these approaches reduce light-emitting diode efficiency due to light absorption in the cathode layers. Another approach involves reducing pixel size to accommodate additional metal lines between the pixels on a thin-film transistor layer. The additional metal lines can reduce cathode resistance, but the area needed to accommodate the additional metal lines reduces pixel aperture and display brightness.

It would therefore be desirable to be able to provide improve ways to distribute signals such as power supply signals on a display such as an organic light-emitting diode display.

### SUMMARY

An electronic device may include a display having an array of organic light-emitting diode display pixels. The display may have a display substrate and thin-film transistor circuitry formed on the substrate.

A pixel definition layer may be formed on the thin-film transistor circuitry. Openings in the pixel definition layer may be provided with emissive material. An anode is formed in each opening under the emissive material. A blanket cathode layer covers the array of pixels and serves as a cathode terminal for an organic light-emitting diode in each pixel. During operation, light is emitted by the emissive material as current passes between the anode and the cathode terminal of each organic light-emitting diode.

Patterned metal on the pixel definition layer may assist in distributing a power supply voltage to the cathode terminals. The patterned metal may be overlapped by patterned black masking material on an encapsulation layer such as a color filter layer.

The pixel definition layer may also be formed from metal that is coated with inorganic dielectric. The cathode may be shorted to a metal pixel definition layer through openings in the inorganic coating.

### BRIEF DESCRIPTION OF THE DRAWINGS

FIG. 1 is a diagram of an illustrative electronic device having a display in accordance with an embodiment.

FIG. 2 is a diagram of an illustrative organic light-emitting diode pixel circuit in accordance with an embodiment.

FIG. 3 is a diagram of an illustrative organic light-emitting diode display in accordance with an embodiment.

FIG. 4 is a cross-sectional side view of a portion of an illustrative organic light-emitting diode display in accordance with an embodiment.

FIG. 5 is a top view of a portion of an illustrative organic light-emitting diode display showing how metal may be deposited on a pixel definition layer around emissive layer regions formed in openings in the pixel definition layer to serve as a supplemental power supply signal distribution path in accordance with an embodiment.

FIG. 6 is a top view of a portion of an illustrative organic light-emitting diode display showing how metal strips may be deposited between rows or columns of emissive layer regions to serve as a supplemental power supply signal distribution path in accordance with an embodiment.

FIG. 7 is a top view of an illustrative organic light-emitting diode display in which supplemental power supply signal distribution lines have been contacted using contact pads running along the edges of the organic light-emitting diode display in accordance with an embodiment.

FIG. 8 is a cross-sectional side view of an edge portion of the illustrative organic light-emitting diode display of FIG. 7 showing a supplemental power supply signal distribution line formed over a pixel definition layer and an associated peripheral contact pad in accordance with an embodiment.

FIG. 9 is a cross-sectional side view of another edge portion of the illustrative organic light-emitting diode display of FIG. 7 showing how the end of a supplemental power supply signal distribution line may overlap an associated edge peripheral contact pad in accordance with and embodiment.

FIG. 10 is a cross-sectional side view of portions of upper and lower substrate layers in an illustrative organic light-emitting diode display in which supplemental power supply signal distribution paths have been formed from metal deposited over a patterned dielectric pixel definition layer in accordance with an embodiment.

FIG. 11 is a cross-sectional side view of a portion of an illustrative organic light-emitting diode display structure in which a supplemental metal power distribution line has been formed within a recessed portion on the top of a pixel definition layer in accordance with an embodiment.

FIG. 12 is a cross-sectional side view of a portion of an illustrative organic light-emitting diode display structure in which a supplemental power distribution line has been enclosed in insulating layers in accordance with an embodiment.

### DETAILED DESCRIPTION

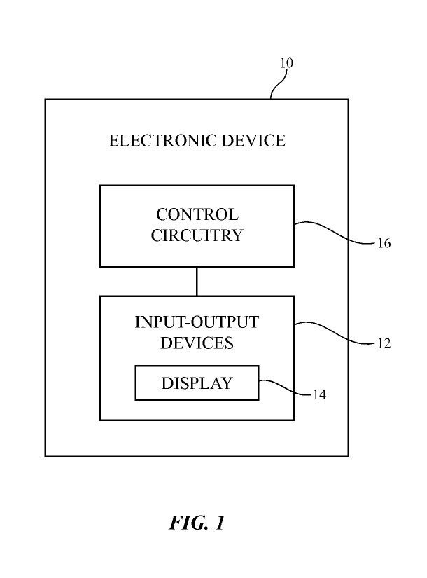

An illustrative electronic device of the type that may be provided with an organic light-emitting diode display is shown in FIG. 1. As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 12 may be used to allow data to be supplied to device 10 and to allow data to be provided from device 10 to external devices. Input-output devices 12 may include buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements. If desired, display 14 may be insensitive to touch (i.e., the touch sensor may be omitted).

Control circuitry 16 may be used to run software on device 10 such as operating system code and applications. During operation of device 10, the software running on control circuitry 16 may display images on display 14.

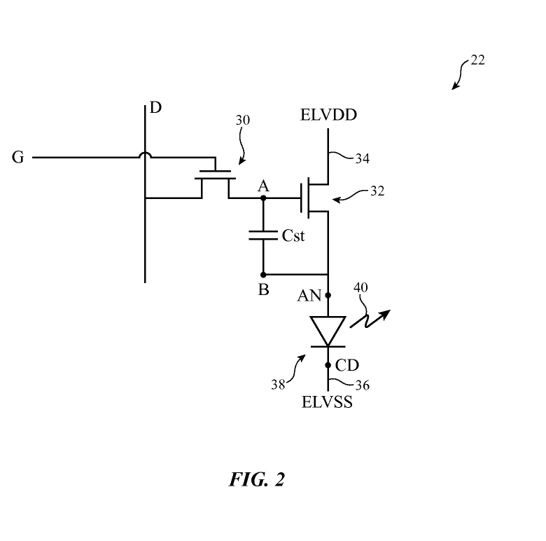

Display 14 may be an organic light-emitting diode display. In an organic light-emitting diode display, each display pixel contains a respective organic light-emitting diode. A schematic diagram of an illustrative organic light-emitting diode display pixel is shown in FIG. 2. As shown in FIG. 2, display pixel 22 may include light-emitting diode 38. A positive power supply voltage ELVDD may be supplied to positive power supply terminal 34 and a ground power supply voltage ELVSS may be supplied to ground power supply terminal 36. Diode 38 has an anode (terminal AN) and a cathode (terminal CD). The state of drive transistor 32 controls the amount of current flowing through diode 38 and therefore the amount of emitted light 40 from display pixel 22. Cathode CD of diode 38 is coupled to ground terminal 36, so cathode terminal CD of diode 38 may sometimes be referred to as the ground terminal for diode 38.

To ensure that transistor 38 is held in a desired state between successive frames of data, display pixel 22 may include a storage capacitor such as storage capacitor Cst. The voltage on storage capacitor Cst is applied to the gate of transistor 32 at node A to control transistor 32. Data can be loaded into storage capacitor Cst using one or more switching transistors such as switching transistor 30. When switching transistor 30 is off, data line D is isolated from storage capacitor Cst and the gate voltage on terminal A is equal to the data value stored in storage capacitor Cst (i.e., the data value from the previous frame of display data being displayed on display 14). When gate line G (sometimes referred to as a scan line) in the row associated with display pixel 22 is asserted, switching transistor 30 will be turned on and a new data signal on data line D will be loaded into storage capacitor Cst. The new signal on capacitor Cst is applied to the gate of transistor 32 at node A, thereby adjusting the state of transistor 32 and adjusting the corresponding amount of light 40 that is emitted by light-emitting diode 38. If desired, the circuitry for controlling the operation of light-emitting diodes for display pixels in display 14 (e.g., transistors, capacitors, etc. in display pixel circuits such as the display pixel circuit of FIG. 2) may be formed using other configurations (e.g., configurations that include circuitry for compensating for threshold voltage variations in drive transistor 32, etc.). The display pixel circuit of FIG. 2 is merely illustrative.

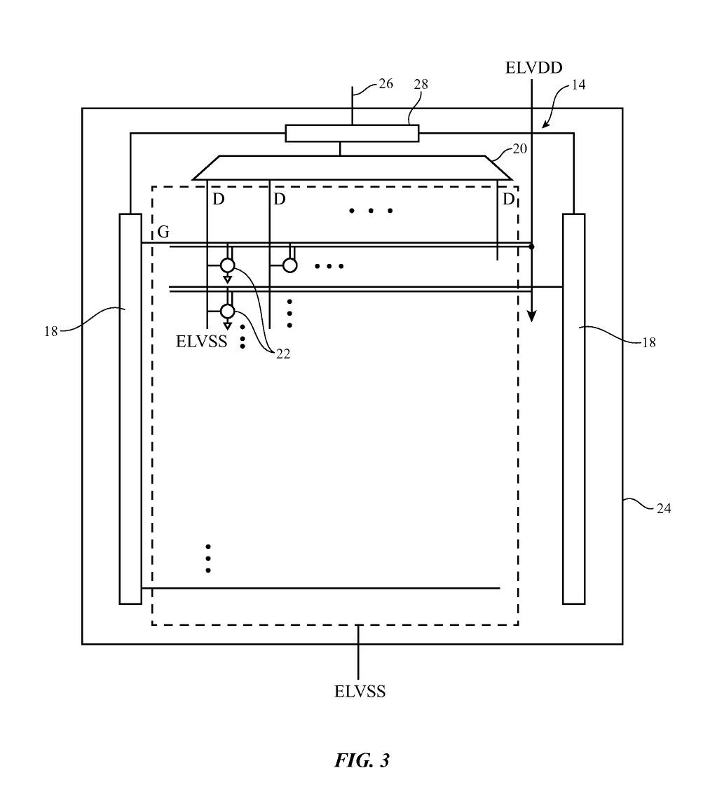

As shown in FIG. 3, display 14 may include layers such as substrate layer 24. Substrate 24 and, if desired, other layers in display 14, may be formed from planar rectangular layers of material such as planar glass layers, planar polymer layers, composite films that include polymer and inorganic materials, metallic foils, etc. Substrate 24 may have left and right vertical edges and upper and lower horizontal edges. If desired, substrate 24 may have non-rectangular shapes (e.g., shapes with curved edges, etc.).

Display 14 may have an array of display pixels 22 for displaying images for a user. Each display pixel may have a light-emitting diode such as organic light-emitting diode 38 of FIG. 2 and associated thin-film transistor circuitry (e.g., the pixel circuit of FIG. 2 or other suitable display pixel circuit). The array of display pixels 22 may be formed from rows and columns of display pixel structures (e.g., display pixels formed from structures on display layers such as substrate 24). There may be any suitable number of rows and columns in the array of display pixels 22 (e.g., ten or more, one hundred or more, or one thousand or more). Display 14 may include display pixels 22 of different colors. As an example, display 14 may include red pixels that emit red light, green pixels that emit green light, and blue pixels that emit blue light. Configurations for display 14 that include display pixels of other colors may be used, if desired. The use of a pixel arrangement with red, green, and blue pixels is merely illustrative.

Display driver circuitry such as display driver integrated circuit(s) 28 may be coupled to conductive paths such as metal traces on substrate 24 using solder or conductive adhesive. Display driver integrated circuit 28 (sometimes referred to as a timing controller chip) may contain communications circuitry for communicating with system control circuitry over path 26. Path 26 may be formed from traces on a flexible printed circuit or other cable. The control circuitry may be located on one or more printed circuits in electronic device 10. During operation, the control circuitry (e.g., control circuitry 16 of FIG. 1) may supply circuitry such as display driver integrated circuit 28 with information on images to be displayed on display 14. Circuitry such as display driver integrated circuits may be mounted on substrate 24 or may be coupled to substrate 24 through a flexible printed circuit cable or other paths.

To display the images on display pixels 22, display driver integrated circuit 28 may supply corresponding image data to data lines D while issuing clock signals and other control signals to supporting display driver circuitry such as gate driver circuitry 18 and demultiplexing circuitry 20.

Demultiplexer circuitry 20 may be used to demultiplex data signals from display driver integrated circuit 28 onto a plurality of corresponding data lines D. With the illustrative arrangement of FIG. 3, data lines D run vertically through display 14. Data lines D are associated with respective columns of display pixels 22. Demultiplexer circuitry 20 may be implemented as part of an integrated circuit such as circuit 28 and/or may be formed from thin-film transistor circuitry on substrate 24.

Gate driver circuitry 18 (sometimes referred to as scan line driver circuitry) may be implemented as part of an integrated circuit such as circuit 28 and/or may be thin-film transistor circuitry that is formed on substrate 24 (e.g., on the left and right edges of display 14, on only a single edge of display 14, or elsewhere in display 14). Gate lines G (sometimes referred to as scan lines) run horizontally through display 14. Each gate line G is associated with a respective row of display pixels 22. If desired, there may be multiple horizontal control lines such as gate lines G associated with each row of display pixels. Gate driver circuitry 18 may be located on the left side of display 14, on the right side of display 14, or on both the right and left sides of display 14, as shown in FIG. 3.

Gate driver circuitry 18 may assert horizontal control signals (sometimes referred to as scan signals or gate signals) on the gate lines G in display 14. For example, gate driver circuitry 18 may receive clock signals and other control signals from display driver integrated circuit 16 and may, in response to the received signals, assert a gate signal on gate lines G in sequence, starting with the gate line signal G in the first row of display pixels 22. As each gate line is asserted, data from data lines D is located into the corresponding row of display pixels. In this way, control circuitry such as display driver circuitry 28, 20, and 18 may provide display pixels 22 with signals that direct display pixels 22 to generate light for displaying a desired image on display 14. More complex control schemes may be used to control display pixels with multiple thin-film transistors (e.g., to implement threshold voltage compensation schemes) if desired.

Display circuits such as demultiplexer circuitry 20, gate line driver circuitry 18, and the circuitry of display pixels 22 may be formed using thin-film transistors on substrate 24. The thin-film transistors in display 14 may, in general, be formed using any suitable type of thin-film transistor technology (e.g., silicon-based transistors such as polysilicon thin-film transistors, semiconducting-oxide-based transistors such as InGaZnO transistors, etc.).

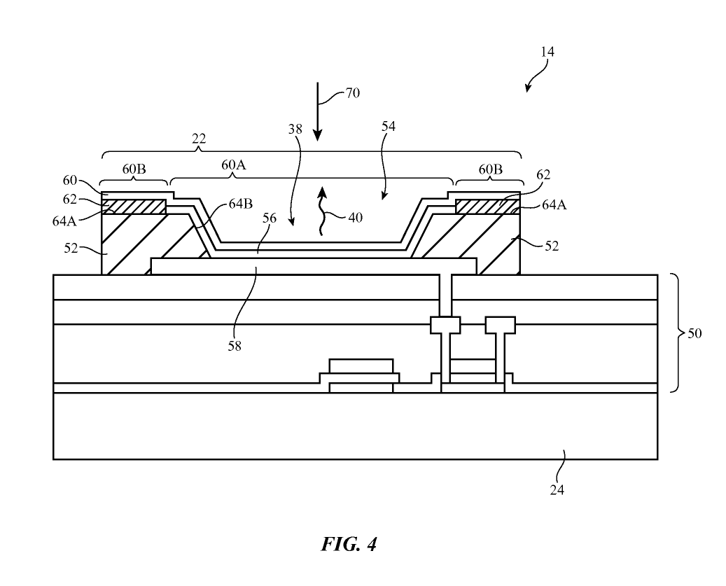

A cross-sectional side view of a configuration that may be used for the pixels of display 14 of device 10 is shown in FIG. 4. As shown in FIG. 4, display 14 may have a substrate such as substrate 24. Thin-film transistors, capacitors, and other thin-film transistor circuitry 50 (e.g., display pixel circuitry such as the illustrative display pixel circuitry of FIG. 2) may be formed on substrate 24. Organic light-emitting diodes such as organic light-emitting diode 38 may be formed from anodes in thin-film transistor circuitry 50 such as anode 58. A blanket cathode layer such as cathode layer 60 may cover all of the display pixels in display 14. Each diode 38 may have an organic light-emitting emissive layer (sometimes referred to as emissive material or an emissive layer structure) such as emissive layer 56. Emissive layer 56 is an electroluminescent organic layer that emits light 40 in response to applied current through diode 38. In a color display, emissive layers 56 in the array of pixels in the display include red emissive layers for emitting red light in red pixels, green emissive layers for emitting green light in green pixels, and blue emissive layers for emitting blue light in blue pixels. In addition to the emissive organic layer in each diode 38, each diode 38 may include additional layers for enhancing diode performance such as an electron injection layer, an electron transport layer, a hole transport layer, and a hole injection layer. Layers such as these may be formed from organic materials (e.g., materials on the upper and lower surfaces of electroluminescent material in layer 56).

Layer 52 (sometimes referred to as a pixel definition layer) has an array of openings such as opening 54 in which emissive material structures such as layer 56 of FIG. 4 are formed and in which anodes 58 for respective diodes 38 are located. At the bottom of opening 54, emissive layer 56 overlaps anode 58. The shape of opening 54 therefore defines the shape of the light-emitting area for diode 38.

Pixel definition layer 52 may be formed from a photoimageable material that is photolithographically patterned (e.g., dielectric material that can be processed to form photolithographically defined openings such as photoimageable polyimide, photoimageable polyacrylate, etc.) or may be formed from material that is deposited through a shadow mask (as examples). Pixel definition layer 52 may form lines that have planar upper surfaces such as upper surfaces 64A and sidewalls such as illustrative sloped sidewalls 64B. Each emissive layer structure 56 may be formed at the bottom of a respective pixel definition layer opening 54 on a respective anode 58 and may be surrounded by sloped sidewalls 62B of pixel definition layer 52. Openings such as opening 54 in pixel definition layer 52 may be rectangular (when viewed from above in direction 70 of FIG. 4) or may have other suitable shapes. If desired, pixel definition layer 52 may form structures with other cross-sectional profiles. The cross-sectional side view of FIG. 4 is merely illustrative.

Substrate 24 may be formed from a material such as glass or other dielectric. An encapsulation structure (not shown in FIG. 4) may be formed over the structures of FIG. 4. The encapsulation structure may include a clear layer of glass, polymer, or other protective material. As an example, the encapsulation structure may form an upper glass layer in display 14. If desired, color filter elements may be formed in an array on the encapsulation layer (e.g., to filter light emitted from display pixels 22). An encapsulation layer that contains an array of color filter elements may sometimes be referred to as a color filter layer or color filter layer substrate. Color filter elements on an encapsulation layer may be aligned with emissive layers 56 and openings 54. For example, a red color filter element on an encapsulating color filter layer may be aligned with a red emissive layer 56 in a red light-emitting diode 38, a green color filter element on the encapsulating color filter layer may be aligned with a green emissive layer 56 in a green light-emitting diode 38, and a blue color filter element on the encapsulating color filter layer may be aligned with a blue emissive layer 56 in a blue light-emitting diode 38. Encapsulation layers without color filter elements may also be used in display 14, if desired.

To ensure that cathode 60 is transparent, it may be desirable to form cathode 60 from a thin layer of metal (e.g., a metal layer with a thickness of less than 100-200 angstroms or other suitable thickness that allows light 40 to pass through cathode 60) and/or layer of a transparent conductive material such as indium tin oxide. By forming cathode layer 60 from materials that are transparent, light 40 may be emitted from light-emitting diode 38 without excessive absorption.

Transparent conductive materials such as indium tin oxide and/or thin metal layers for cathode 60 may exhibit relatively high sheet resistance. As a result, power supply signals flowing through cathode layer 60 (e.g., ground power supply voltage ELVSS) may exhibit undesired variations across display 14. Power supply signals ELVDD and ELVSS may be applied to display 14 using peripheral contact pads located on the edge of substrate 24. Cathode 60 distributes power supply signals ELVDD inwardly from the edge of display 14 towards the center of display 14. As a power supply current of magnitude I flows through the non-negligible resistance R associated with cathode layer 60, there is a risk that voltage level of ELVSS will vary significantly from its desired level due to IR losses.

To prevent IR losses from giving rise to undesired spatial variation in power supply signals (i.e., to ensure that ELVSS is uniformly equal to 0 volts or other desired voltage level across cathode 60, display 14 may be provided with supplemental power supply signal distribution paths. For example, lines of metal or metal that has other suitable shapes (e.g., a grid pattern that surrounds openings 54) may be deposited over some or all of pixel definition layer 52. As shown in FIG. 4, for example, metal layer 62 may be formed on pixel definition layer 52 under portions 60B of cathode 60, but not under those portions of cathode 60 that overlap layer 56 (i.e., not under portions 60A of cathode 60). Metal 62 may, as an example, be patterned to have a width that is slightly less than the width of planar upper surface 64A of pixel definition layer 52 and may have a thickness of less than two microns (as an example).

In general, metal layer 62 may lie exclusively within planar upper pixel definition layer surfaces 64A or may cover planar surface 64A and part of sloped pixel definition layer sidewalls 64B. Metal layer 62 may have a relatively large thickness (e.g., 1000 angstroms or more as an example) to ensure that the resistance of metal layer 62 will be low. Metal 62 is in contact with cathode layer 60 so that metal 62 is shorted to cathode 60. Metal 62 has a lower resistance than layer 60 and therefore forms supplemental power supply signal paths. The presence of metal 62 in contact with cathode layer 60 reduces the sheet resistance of the cathode in display 14 and therefore minimizes or eliminates variations in power supply voltage ELVSS across display 14. Because metal 62 helps distribute power supply voltage ELVSS for the cathode, all display pixel circuits for pixels 22 in display 14 will receive substantially equal values of ELVSS and display pixels 22 will emit light uniformly.

Metal layer 62 is only formed over pixel definition layer 52 and is not deposited within openings 54. As a result, the presence of metal layer 62 does not affect the efficient emission of light 40 from light-emitting diode 38. Metal layer 62 may be formed from a metal such as an alloy of magnesium and gold, aluminum, copper, silver, gold, or other suitable metals. Metal 62 may be deposited by thermal evaporation or other suitable deposition techniques.

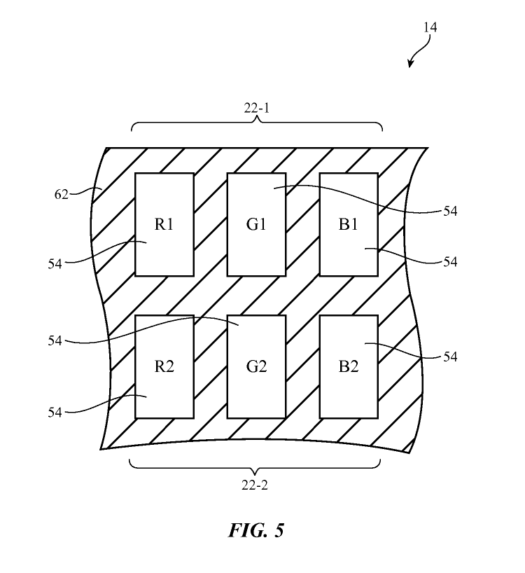

FIG. 5 is a top view of a portion of an illustrative organic light-emitting diode display showing how metal 62 may be formed in a grid pattern that surrounds emissive layer regions 54. Two illustrative sets of display pixels are shown in FIG. 5: display pixels 22-1 (e.g., a red display pixel R1, a green display pixel G1, and a blue display pixel B1) and display pixels 22-2 (e.g., a red display pixel R2, a green display pixel G2, and a blue display pixel B2).

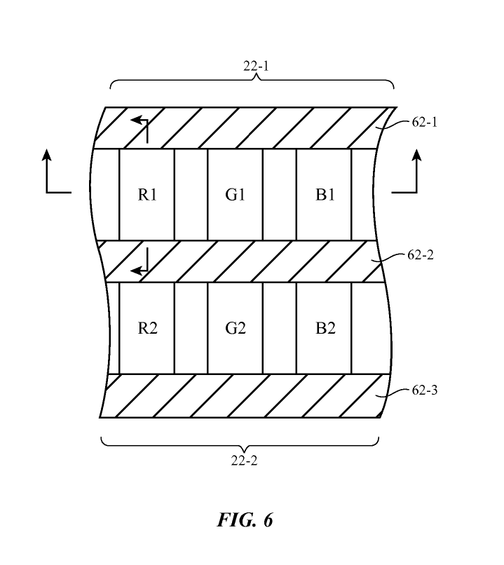

If desired, supplemental power supply distribution paths may be formed by depositing metal 62 in continuous (unbroken) lines or in segmented lines, as illustrated by metal lines 62-1, 62-2, and 63-3 of FIG. 6.

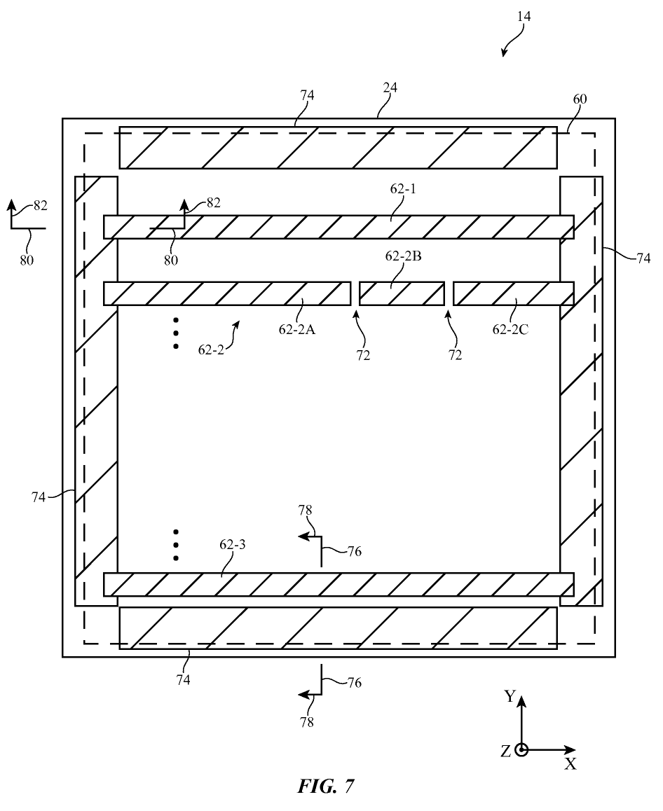

FIG. 7 is a top view of an illustrative organic light-emitting diode display with supplemental power supply signal distribution paths. In the example of FIG. 7, display 14 includes a series of horizontal metal strips such as strips 62-1, 62-2, and 62-3 that serve as supplemental power supply signal distribution paths. Each metal strip overlaps a respective strip-shaped portion of pixel definition layer 52. As shown by illustrative gaps 72 in line 62-2, some or all of the metal strips may be segmented. In the FIG. 7 example, line 62-2 has a metal segment 62-2B that lies between line portions 62-2A and 62-2C, but, in general, supplemental power supply paths may be formed from metal lines with any suitable number of segments (e.g., one or more segments, ten or more segments, 100 or more segments, etc.). The use of segmented lines may facilitate fabrication (e.g., when using a shadow mask that has stencil-shaped openings to deposit metal 62). If desired, a shadow mask may be moved during metal deposition so that the stencil in the shadow mask can be used to create unbroken supplemental lines. In configurations in which the stencil is not moved, the shadow mask may be used in forming segmented metal lines (e.g., metal lines with segments that are each about 50 by 100 microns in area or other suitable line segments). Cathode 60 is shorted to the segments, so the segments are all electrically connected to each other.

Display 14 of FIG. 7 has contact pads 74. Contact pads 74 may be formed from strips of metal running along the peripheral edges of the organic light-emitting diode display, may be formed from a continuous ring of metal, or may be implemented using other peripheral metal structures. Peripheral contact pads 74 of FIG. 7 may be overlapped by the four edges of rectangular cathode layer 60. Supplemental metal lines such as lines 62-1, 62-2, and 62-3 may overlap pads 74 near the edges of display 14 (e.g., on the right and left edges of display 14 in the example of FIG. 7).

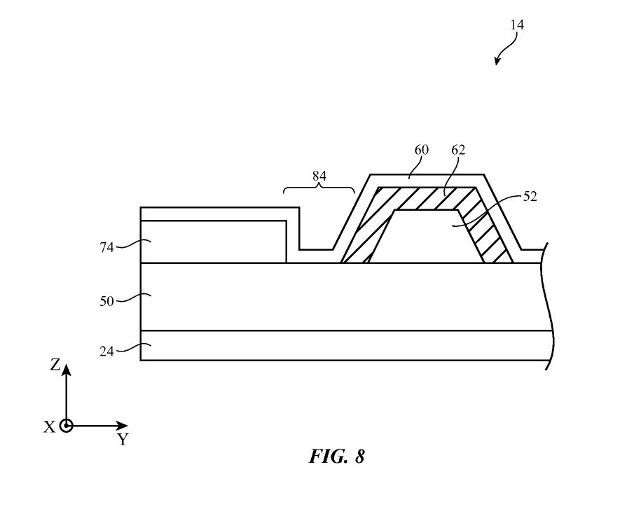

FIG. 8 is a cross-sectional side view of an edge portion of the illustrative organic light-emitting diode display of FIG. 7 taken along line 76 of FIG. 7 and viewed in direction 78. As shown in FIG. 8, a gap such as gap 84 may separate the metal of peripheral contact 74 from metal 62 on pixel definition layer 52. Cathode layer 60 overlaps lines 62 and 74 and is shorted to lines 62 and 74 (and shorts lines 62 and 74 together). If desired, metal 62 may overlap metal pad 74 (e.g., the lower edge of line 62-3 of FIG. 7 may overlap the lowermost contact 74 in FIG. 7.

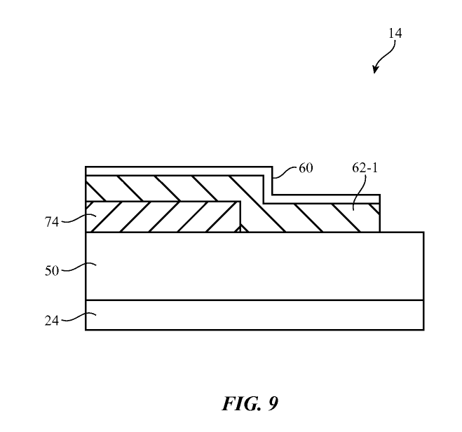

FIG. 9 is a cross-sectional side view of another edge portion of the illustrative organic light-emitting diode display of FIG. 7. The cross-sectional side view of FIG. 9 is taken along line 80 of FIG. 7 and is viewed in direction 82. As shown in the example of FIG. 9, supplemental power supply line 62-1 overlaps contact pad 74 and is therefore shorted to contact pad 74. Cathode layer 60 covers line 64-1 and is shorted to contact 74 through line 64-1. Portions of cathode layer 60 also directly overlap contact 74, as shown in FIG. 7.

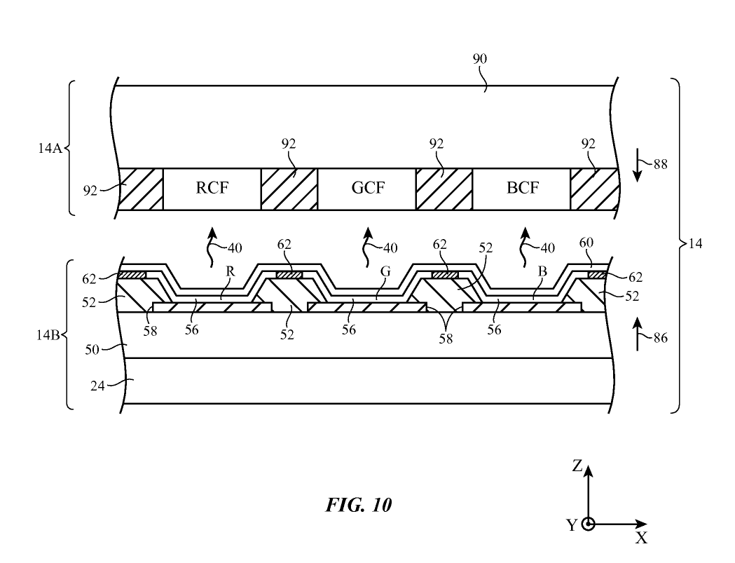

As shown in FIG. 10, display 14 may include thin-film transistor layer portion 14B and encapsulation layer portion 14A. Portions 14A and 14B may be assembled together to form display 14 by moving portion 14A in direction 88 and moving portion 14B in direction 86.

Encapsulation layer 14A may be a color filter layer having color filter layer substrate 90 (e.g., a layer of transparent glass, clear plastic, etc.). Opaque masking layer 92 may be patterned to form a grid-shaped opaque mask (e.g., a black masking layer with an array of openings for display pixels 22, sometimes referred to as a black matrix). The opaque mask may have openings that receive respective color filter elements such as red color filter element RCF, green color filter element GCF, and blue color filter element BCF. The color filter elements of color filter layer 14A may be aligned with respective colored emissive layers 56. For example, red color filter element RCF may be laterally aligned (in dimensions X and Y) with red (R) emissive layer 56, green color filter element GCF may be laterally aligned with green (G) emissive layer 56, and blue color filter element BCF may be laterally aligned with blue (B) emissive layer 56. The opaque material of masking layer 92 may be aligned with pixel definition layer 52 and overlapping metal 62. Because the black masking layer 92 overlaps metal 62, reflections from metal 62 will be blocked (i.e., lines 62 are covered with the overlapping black matrix of material 92 when the color filters of layer 14A are aligned with emissive layers 56 of layer 14B) and will therefore not be visible to a user of display 14.

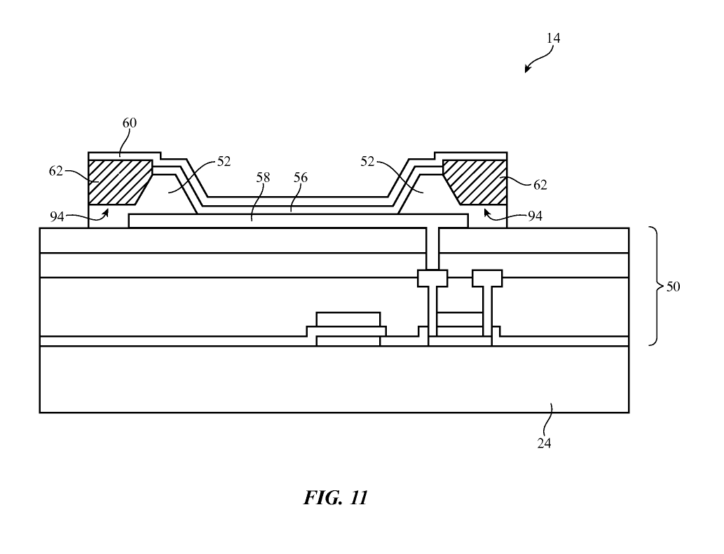

In the illustrative configuration of FIG. 11, a half-tone photolithographic mask has been used to pattern pixel definition layer 52. By using a half-tone mask, grooves or other recesses may be formed in pixel definition layer 52 (see, e.g., recessed areas such as areas 94). Metal 62 may protrude downward into recesses 94. This enhances the thickness of lines 62 and lowers the resistance of the cathode. The width of pixel definition layer 52 may be 20 microns larger than the width of metal lines 62 or other suitable size. As an example, pixel definition layer surface 64A may be 100 microns wide and metal 62 may be 80 microns wide. Other dimensions may be also be used for lines 62 and pixel definition layer 52.

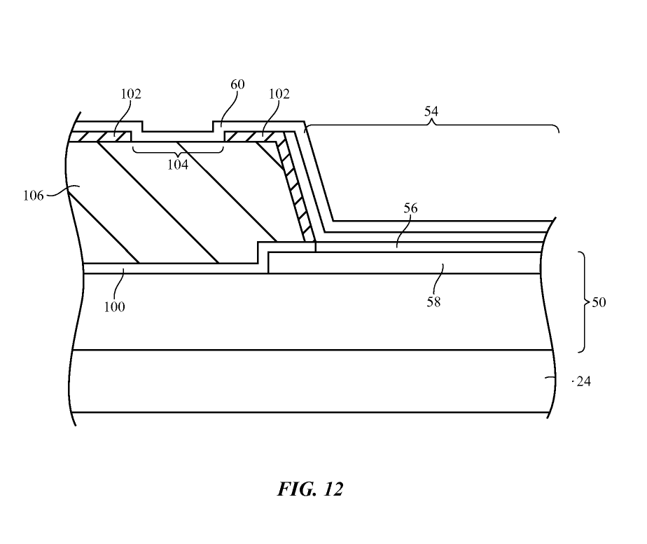

If desired, metal may be deposited that serves both as a pixel definition layer and as supplemental power supply paths. This type of configuration is shown in FIG. 12. As shown in FIG. 12, metal 106 may have the shape of a pixel definition layer. Metal 106 may, for example, be patterned to form a grid of openings 54 for respective emissive layer structures 56 that overlap anodes 58 for respective display pixels 22. The surfaces of metal structures 106 may be coated with insulator. For example, metal 106 may be deposited on a thin insulating layer such as insulating layer 100 and may be coated with a thin insulating coating such as insulating coating 102. Layer 100 and coating 102 may, for example, be inorganic insulators such as silicon oxide, metal oxide (e.g., Al₂O₃), other oxides, nitrides, oxynitrides, may be polymers, etc. Contact openings such as opening 104 of FIG. 13 may be formed in coating layer 102 to allow cathode layer 60 to contact metal 106 and thereby be shorted to metal 106. Metal 106 may have a matrix (grid) pattern, may include multiple parallel lines, may be used without using photopatterned pixel definition layer material on substrate 24, may be used in combination with areas of photopatterned pixel definition layer material (e.g., photolithographically patterned photoimageable polymer), or may have other configurations.

The foregoing is merely illustrative and various modifications can be made by those skilled in the art without departing from the scope and spirit of the described embodiments. The foregoing embodiments may be implemented individually or in any combination.

What is claimed is:

1. An organic light-emitting diode display having an array of pixels, comprising:
a substrate;
a layer of thin-film transistor circuitry on the substrate;
a pixel definition layer on the layer of thin-film transistor circuitry, wherein the pixel definition layer has openings each of which contains an organic emissive layer for an organic light-emitting diode and each of which is associated with a respective one of the pixels;
a cathode layer that covers the array of pixels and that distributes a ground power supply voltage to the organic light-emitting diode in each of the openings; and
patterned metal on the pixel definition layer that is shorted to the cathode layer and forms supplemental power supply distribution paths to help distribute the ground power supply voltage.

2. The organic light-emitting diode display defined in claim 1 wherein the patterned metal comprises a plurality of metal lines.

3. The organic light-emitting diode display defined in claim 2 further comprising a peripheral contact pad on the display substrate, wherein each of the plurality of metal lines has a portion that overlaps and shorts to the peripheral contact pad.

4. The organic light-emitting diode display defined in claim 1 wherein the patterned metal comprises a plurality of segmented metal lines deposited through a shadow mask.

5. The organic light-emitting diode display defined in claim 1 further comprising:
first and second peripheral contact pads on opposing edges of the display substrate, wherein the patterned metal comprises metal lines that extend across the substrate from the first peripheral contact pad to the second peripheral contact pad.

6. The organic light-emitting diode display defined in claim 1 wherein the pixel definition layer comprises recesses that lie within portions of the pixel definition layer between the openings and wherein the patterned metal extends into the recesses.

7. The organic light-emitting diode display defined in claim 1 wherein the patterned metal surrounds each of the openings.

8. The organic light-emitting diode display defined in claim 1 wherein the layer of thin-film transistor circuitry includes anodes, wherein the openings include rectangular openings, and wherein a respective one of the anodes is located within each opening under the organic emissive layer in that opening.

9. The organic light-emitting diode display defined in claim 1 wherein portions of the pixel definition layer between the openings include planar upper surface regions between respective sloped surface regions and wherein the patterned metal is confined within the planar upper surface regions and that does not cover the sloped surface regions.

10. The organic light-emitting diode display defined in claim 9 wherein the pixel definition layer comprises photoimageable polymer.

11. The organic light-emitting diode display defined in claim 1 wherein the pixel definition layer comprises polymer and wherein the openings are photolithographically defined rectangular openings in the polymer.

12. The organic light-emitting diode display defined in claim 1 further comprising an encapsulation layer, wherein the encapsulation layer has a patterned black mask that overlaps the pixel definition layer.

13. The organic light-emitting diode display defined in claim 12 wherein the patterned black mask has openings that include color filter elements that are aligned with the openings in the pixel definition layer.

14. An organic light-emitting diode display having an array of pixels, comprising:
a substrate;
a layer of thin-film transistor circuitry on the substrate;
a metal pixel definition layer on the layer of thin-film transistor circuitry, wherein the metal pixel definition layer has openings each of which contains an organic emissive layer for an organic light-emitting diode and each of which is associated with a respective one of the pixels; and
a cathode layer that covers the array of pixels, wherein the cathode layer receives a ground power supply voltage and distributes the ground power supply voltage to the organic emissive layers in the openings and wherein the metal pixel definition layer is shorted to the cathode layer.

15. The organic light-emitting diode display defined in claim 14 further comprising an insulating coating on the metal pixel definition layer.

16. The organic light-emitting diode display defined in claim 15 wherein the insulating coating comprises an inorganic dielectric having an opening through which the cathode is shorted to the metal pixel definition layer.

17. The organic light-emitting diode display defined in claim 14 further comprising a color filter layer that encapsulates the display, wherein the color filter layer includes a glass layer covered with a patterned black mask and wherein the patterned black mask has openings that include color filter elements that are aligned with the openings in the pixel definition layer.

18. An organic light-emitting diode display having an array of pixels, comprising:
a lower glass substrate;
thin-film transistor circuitry on the lower glass substrate;
a polymer pixel definition layer patterned on the thin-film transistor circuitry, wherein the polymer pixel definition layer has openings each of which is associated with a respective pixel in the array of pixels and each of which contains an organic emissive layer for an organic light-emitting diode in a respective one of the pixels;
a blanket cathode layer that covers the array of pixels, wherein the blanket cathode layer distributes a power supply voltage to the organic emissive layer in each of the openings;
patterned metal overlapping the polymer pixel definition layer, wherein the patterned metal is interposed between the polymer pixel definition layer and the blanket cathode layer and helps distribute the power supply voltage; and
an upper glass substrate having a patterned black mask with openings that are aligned with the openings in the polymer pixel definition layer.

19. The organic light-emitting diode display defined in claim 18 wherein the patterned metal comprises metal lines.

20. The organic light-emitting diode display defined in claim 18 wherein the patterned metal comprises segmented metal lines.
